(19) United States
(12) Patent Application Publication
(10) Pub. No.: US 2024/0386455 A1
(43) Pub. Date: Nov. 21, 2024

(54) AUTOMATICALLY ASSESSING REFERRALS

(71) Applicant: eXp Realty, LLC, Bellingham, WA (US)

(72) Inventors: Kurt Brooks Uhlir, Roswell, GA (US); Alan Scott Pinstein, Decatur, GA (US); Michael David Chatman, Marietta, GA (US); Scot Bohl, Takoma Park, MD (US); Scott Graeme Lockhart, Atlanta, GA (US); Spondon Kath Hazarika, Quincy, MA (US); Samuel Christopher Wade, Acworth, GA (US)

(21) Appl. No.: 18/317,720

(22) Filed: May 15, 2023

(51) Int. Cl. G06Q 30/0214; G06F 40/40; G06Q 30/018; G06Q 30/0207; G06Q 50/16; G06Q 50/26

(52) U.S. Cl. CPC G06Q 30/0214; G06F 40/40; G06Q 30/018; G06Q 30/0215; G06Q 50/16; G06Q 50/26

(57) ABSTRACT

A facility for automatically assessing referrals is described. The facility discerns first information about a referral by a referrer for a subject property being processed by a referral system. The discerned information includes a property jurisdiction of the referral in which the subject property is located, a referrer jurisdiction of the referral, and a category of service of the referral. The facility identifies one or more referral rule representations stored in a rule store for the discerned property jurisdiction. The facility applies the identified one or more referral rule representations to the discerned first information to obtain a determination regarding the compliance of the referral with referral rules to which the identified one or more referral rule representations correspond. The facility acts in response to the determination.

### BACKGROUND

A referral involves a referrer conveying to a provider an opportunity to serve a consumer. For example, a first real estate agent may convey to a second real estate agent an opportunity to assist a prospect in acquiring property in a particular jurisdiction. In some cases, a provider pays a referral fee to the referrer.

### BRIEF DESCRIPTION OF THE DRAWINGS

FIG. 1 is a block diagram showing some of the components typically incorporated in at least some of the computer systems and other devices on which the facility operates.

FIG. 2 is a data flow diagram showing a process used by the facility to automatically assess referrals in some embodiments.

FIG. 3 is a flow diagram showing a process performed by the facility in some embodiments to construct and maintain its rule store, such as in its interpreter.

FIG. 4 is a table diagram showing sample contents of a rule store table maintained by the facility in some embodiments to represent current referral rules in jurisdictions covered by the facility.

FIG. 5 is a flow diagram showing a process performed by the facility in some embodiments to process rule application requests, such as in the facility's rules engine.

FIG. 6 is a flow diagram showing a process performed by the facility in some embodiments to generate rule application requests, such as in its monitor.

FIG. 7 is a flow diagram showing a process performed by the facility in some embodiments to compensate a referring agent for a referral.

### DETAILED DESCRIPTION

The inventors have recognized that different jurisdictions impose a variety of different rules about the referrals that can be made, the form they must take, and whether and how referral fees may properly be paid to referrers by providers. These determinations often hinge on such details as the state or other jurisdiction where the property that is the subject of the referral is located; the jurisdiction where the referrer lives, works, or is licensed; the type of referral being made; the particular details of how the referral is made; the licensure level or status of the referrer and/or the provider; etc. The inventors have further recognized that these factors complicate the process of making referrals between jurisdictions, which creates disincentives to making cross-jurisdiction referrals, which in turn limit the extent to which cross-jurisdiction referrals are made and can benefit those involved.

In response to these recognitions, the inventors have conceived and reduced to practice a software and/or hardware facility for automatically assessing referrals (“the facility”), including cross-jurisdiction referrals.

In some embodiments, the facility automatically periodically retrieves sources of authority about referral rules, such as those promulgated by legislatures and administrative agencies in various jurisdictions. The facility interprets these sources of authority to construct and update a rule store representing the interpreted rules. In various embodiments, the interpreted rules represented in the rule store include combinations of aspects that can include, for a jurisdiction: a license portability category; jurisdictions having reciprocity; and requirements for licensing, advertising, disclosure, privacy, and/or the payment of referral fees.

In some embodiments, a rules engine of the facility responds to rule application requests by retrieving the relevant rules from the rules store and applying them to details about a referral scenario specified by the request. For example, in some embodiments, a monitor of the facility observes referrals being made by a referral system and their progression to and through sale transactions, and submits such requests to determine (1) whether the referral and proposed referral fee payment is proper under the rules, and (2) whether any details must or should be adjusted to better comply with the rules.

In some embodiments, the facility includes a payments engine that causes referral fees to be paid in accordance with referrals resulting in completed sale transactions, in accordance with the details of the referral and the application of the relevant rules. In various embodiments, the facility causes such payment to be made in a variety of ways to more fully comply with relevant rules.

By operating in some or all of the ways described above, the facility reduces or eliminates the disincentives to making cross-jurisdiction referrals that result from their complexities, increasing the rate at which they are made and enabling those involved to benefit.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by storing interpreted representations of referral rules for application, the facility obviates network capacity that would otherwise be used to access the sources of authority for rules in response to every rule application request, as well as the computing resources needed to interpret the sources of authority before applying the rules.

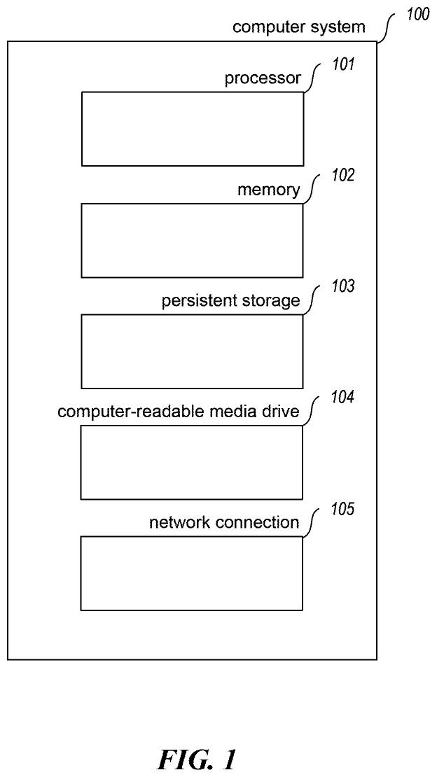

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

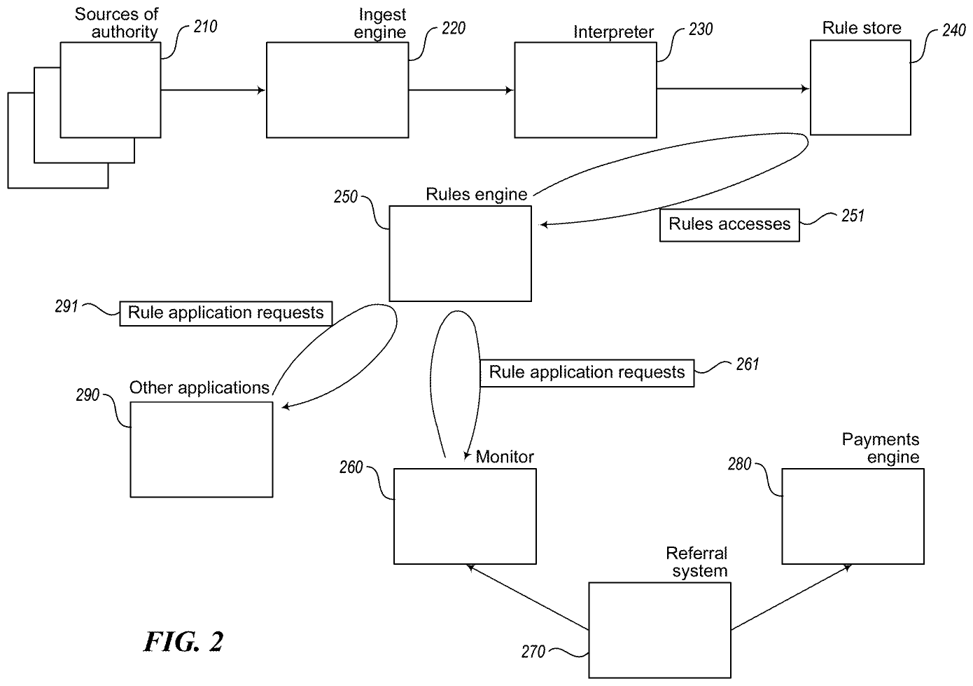

FIG. 2 is a data flow diagram showing a process used by the facility to automatically assess referrals in some embodiments. An ingest engine 220 provided by the facility accesses a number of sources of authority 210 for various geographical and/or legal jurisdictions covered by the facility. The ingest engine subjects the sources of authority that it ingests to an interpreter 230 of the facility for analysis.

The interpreter causes the new or revised rules that it identifies in sources of authorities to be stored in a rule store 240 maintained by the facility. In some embodiments, the interpreter stores these rules in the rule store in a form selected to facilitate their automatic application by the facility.

A rules engine 250 of the facility receives rule application requests, such as rule application requests 261 from a monitor component 260 of the facility, and rule application requests 291 from other applications 290. Each rule application requests specifies facts about a proposed or actual referral—and, in some cases, about a transaction completed subsequent to this referral—for the rules engine to make an assessment of, relying on rules accesses 251 to the rule store. In some embodiments, the monitor performs its monitoring with respect to activity of a referral system 270 of the facility, which interacts with a payments engine 280 of the facility to effect the compensation of the referrers who are the source of referrals for those referrals that result in completed transactions. In some embodiments, the monitor performs additional actions, including maintaining a history of referrals and the property and prospective buyer to which each relates; monitoring for completed sales transactions for particular properties by particular buyers; and matching sales transactions with referrals for the same property and prospective buyer.

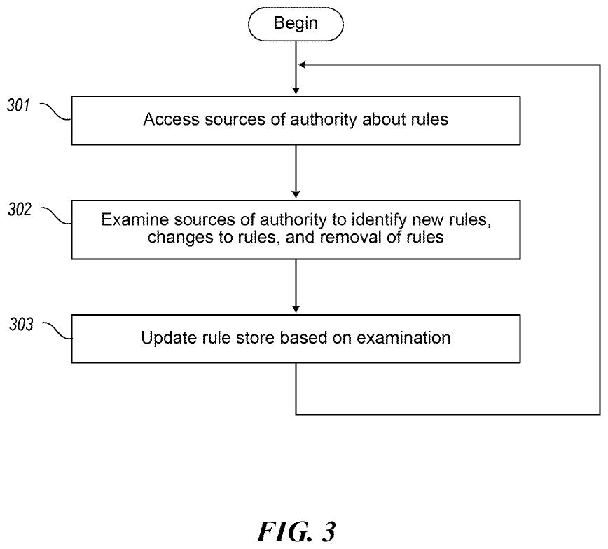

FIG. 3 is a flow diagram showing a process performed by the facility in some embodiments to construct and maintain its rule store, such as in its interpreter. In act 301, the facility accesses sources of authority about referral rules in the jurisdictions covered the facility, such as cities, counties, states, groups of states, countries, groups of countries, etc. In various embodiments, the sources of authority include constitutions, statutes, regulations and other administrative rulemakings, executive orders, and/or comments on or synthesis of any of the foregoing. In various embodiments, the facility accesses these sources of authority in various ways, such as by requesting webpages, Word documents, PDFs, etc., and scraping their contents; calling a retrieval API exposed by the promulgator of the source of authority, its distributor, or other publisher or provider of the source of authority; causing printed or other visual representations of the sources of authority to be scanned or otherwise visually captured and OCRed; having the sources of authority transcribed; etc. In various embodiments, the ingest engine ingests sources of authority at various times, such as periodically, at intervals such as one hour, one day, one week, one month, one quarter, one year, two years, five years, etc.; in response to notifications from or about the sources of authority, indicating that they have changed; etc.

In act 302, the facility examines the sources of authority accessed in act 301 to identify new rules relative to those in the rule store, changes to rules represented in the rule store, or the removal of rules represented in the rule store. In particular, the interpreter automatically discerns rules in each source of authority. In various embodiments, the interpreter does so using natural language processing tools, such as parsers, dedicated natural language extraction and/or summarization tools, large language models and other generative machine learning tools, pattern-matching systems, etc. In some embodiments, the facility enlists one or more human experts in the identification and/or interpretation of rules in sources of authority, and/or adjustment of rule representations in the rule store. In various embodiments, the enlistment of human experts is substituted for or additive to the automatic analysis described above.

In act 303, the facility updates the rule store based on the examination of act 302. After act 302, the facility continues in act 301 to again access the sources of authority at a later time.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

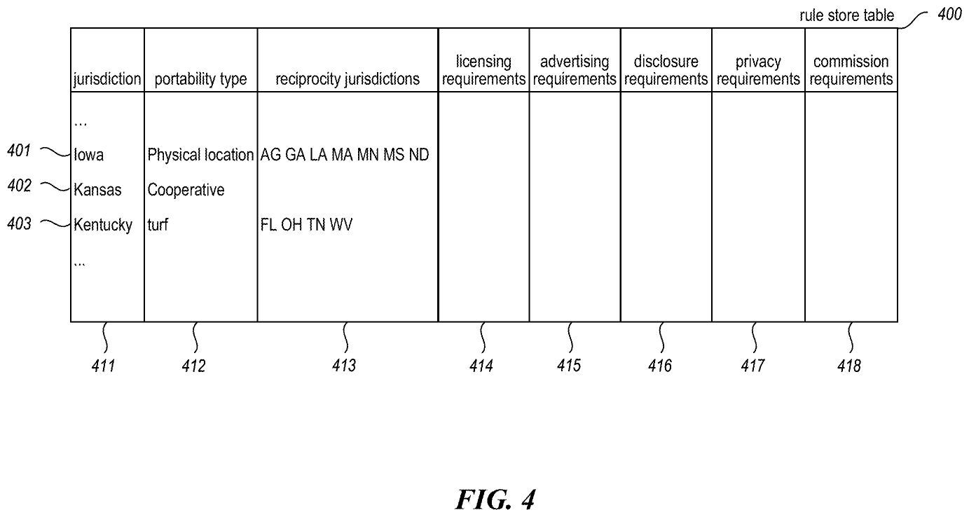

FIG. 4 is a table diagram showing sample contents of a rule store table maintained by the facility in some embodiments to represent current referral rules in jurisdictions covered by the facility. The rule store table 400 is made up of rows, such as 401-403, each corresponding to a jurisdiction covered by the facility. Each row is divided into the following columns: a jurisdiction column 411 identifying the jurisdiction to which the row corresponds; a portability column 412 indicating a license portability category specified by the jurisdiction to determine how agents and others not licensed in the jurisdiction are able to sell property and/or share information about a property that is located in the jurisdiction, make referrals for such sales, and receive referral fee payments for such sales; a reciprocity jurisdictions column 413 identifying other jurisdictions with which the jurisdiction to which the row relates is willing to accord special privileges to agents licensed in these reciprocal jurisdictions;—in some cases, agents may be required to pass a state-specific exam or complete additional continuing education requirements to take advantage of reciprocity; a licensing requirements column 414 containing details about what agents must do to be licensed at various levels of licensure in the jurisdiction, and/or in reciprocal jurisdictions; an advertising requirements column 415 specifying requirements the jurisdiction imposes on advertising or otherwise disseminating information about listings in the jurisdictions, including Fair Housing Act compliance and disclaimers; a disclosure requirements column 416 specifying requirements the jurisdiction has for disclosing accurate information about properties such as properties listed for sale and the agents involved in the referral, including their brokerages; a privacy requirements column 417 specifying requirements imposed by the jurisdiction on maintaining the privacy of people involved with property referrals and sales; and a referral fee requirements column 418 specifying requirements imposed by the jurisdiction on referral fees that may be paid to people involved in the referrals and sale of property in jurisdiction.

For example, row 401 indicates that, in the jurisdiction of Iowa, the portability category is physical location portability, meaning that an agent licensed in any state can do most or all marketing and sales activities in the state from a remote location—but not in person in the state—and can properly receive a referral fee. Row 401 also indicates that the following states have reciprocity with Iowa: Arkansas, Georgia, Louisiana, Massachusetts, Minnesota, Mississippi, and North Dakota. Row 402 indicates that, in the jurisdiction of Kansas, the portability category is cooperative, meaning that an agent licensed in another state can participate in marketing and selling a home in Kansas in explicit cooperation with an agent licensed in Kansas, and is eligible to receive a referral fee once they have filed a co-brokerage agreement documenting that cooperation. In some cases, agents may need to obtain a limited non-resident license or follow other specific rules set by the cooperating states in order to take advantage of a state's cooperative portability category. Row 403 indicates that, in the jurisdiction of Kentucky, the portability category is turf portability, meaning that an agent licensed in another state cannot practice any real estate business in Kentucky, and cannot properly receive compensation for property sales within Kentucky. Row 403 further indicates that the jurisdiction of Kentucky has reciprocity with Florida, Ohio, Tennessee, and West Virginia.

While FIG. 4 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc. Additionally, in some embodiments, rather than storing the data shown in the table diagrams in tables, the facility stores it in semi-structured or unstructured data stores, such as JSON objects.

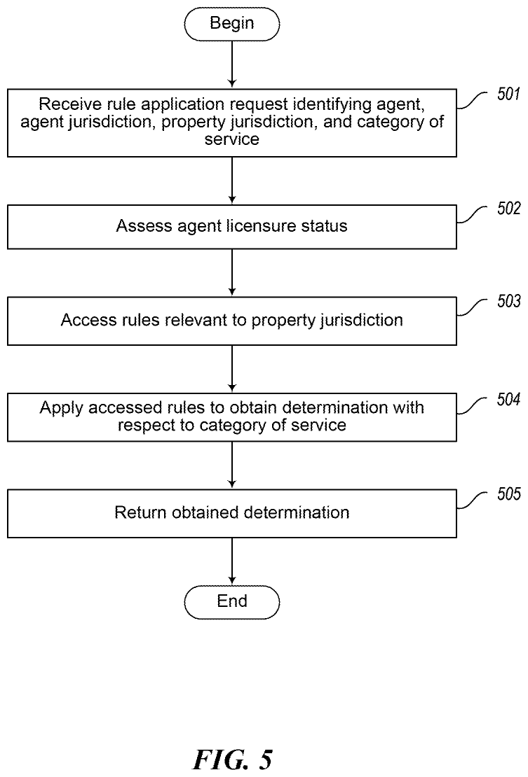

FIG. 5 is a flow diagram showing a process performed by the facility in some embodiments to process rule application requests, such as in the facility's rules engine. In act 501, the facility receives the rule application request. In some embodiments, the request identifies a particular referring agent, one or more jurisdictions in which the agent is licensed, a jurisdiction in which the referred property is located, the identity of a property, a prospective buyer of the property, and a category of service to be evaluated for the referral. In act 502, the facility assesses the licensure status of the agent, such as by accessing a profile established by the agent with the facility that contains this information, querying a jurisdiction licensure database, calling an interface exposed by a broker or agency employing the agent, etc. In act 503, the facility accesses one or more rules relevant to the property jurisdiction, such as rules represented in the rule store table. In act 504, the facility applies the accessed rules to obtain a determination with respect to the category of service. In various embodiments, these determinations can include that the category of service performed by the referring agent with respect to the property is proper; is improper; or requires specific terms in order to be proper. In some embodiments, these determinations include subacts such as verifying the licensing information of the agents involved; determining the operating area of agents involved; checking for reciprocal agreements or cooperative licensing agreements between the states involved; and determining where an agent must be licensed for them to be the proper target of a referral. In act 505, the facility returns the obtained information to the caller, such as the monitor. After act 505, the steps conclude.

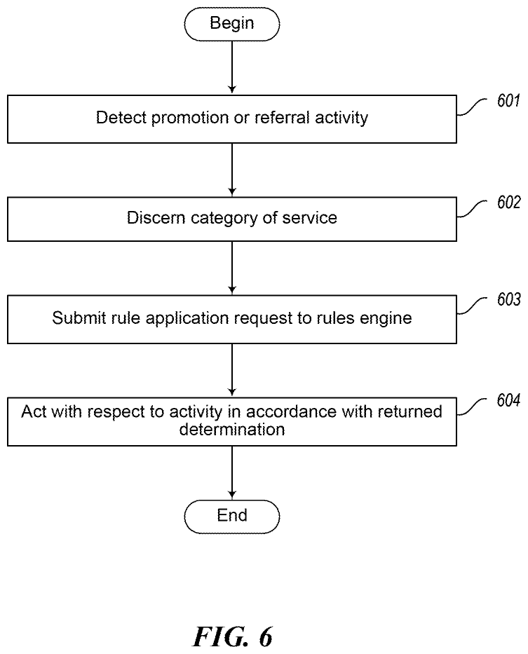

FIG. 6 is a flow diagram showing a process performed by the facility in some embodiments to generate rule application requests such as in its monitor. In act 601, the facility detects promotion or referral activity by an agent with respect to a property. In various embodiments, the facility applies varies approaches to this detection, including monitoring traffic through the referral system; registering with the referral system to be called with referral requests, referral documents and content, etc., being processed by the referral system; etc. In various embodiments, the forms of referrals detected by the facility take a variety of forms, such as referrals generated in a dedicated referral system by the referring agent for receipt and review by an agent to whom the referral is directed; messages sent through general-purpose messaging platforms, such as email messages, SMS messages, Facebook Messenger messages; etc. In act 602, the facility discerns in the activity detected in act 601 a category of service. In some embodiments, the facility uses natural language processing tools such as large language models to analyze conversations to perform the detection of act 601, and/or to perform the discerning of act 602.

In act 603, the facility submits to the rules engine a rule application request containing the detected and discerned information. In act 604, the facility acts with respect to the detected activity in accordance with the determination returned by the rules engine in response to the rule application request. After 604, this process concludes.

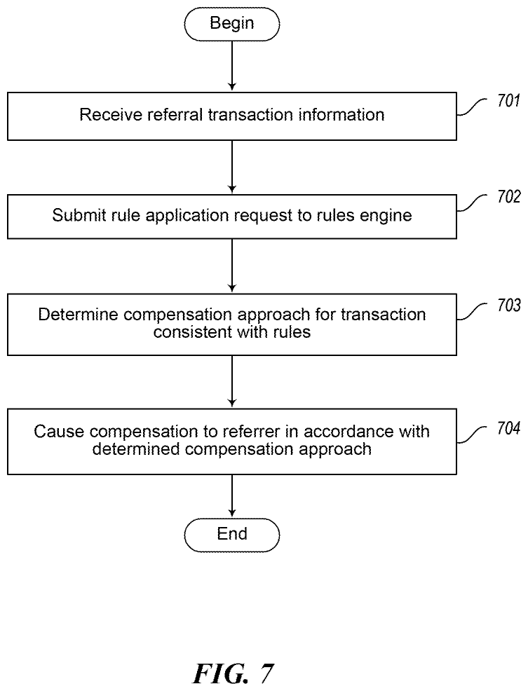

FIG. 7 is a flow diagram showing a process performed by the facility in some embodiments to compensate a referring agent for a referral. In act 701, the facility receives information about a completed transaction for a property that was the subject of a referral. In some embodiments, the facility performs act 701 by receiving information about a more complete set of completed property transactions and filters it against a list of referrals for particular properties compiled by the facility, such as in its monitor. In some embodiments, the information about the completed transaction identifies a sold property, the buyer, the amount paid, and the commission incurred. In act 702, the facility submits a rule application request to the rules engine containing details about the referral and transaction. In act 703, in response to receiving a response to the rule application requests, the facility determines a compensation approach to use to compensate the referring agent that is consistent with the rules governing referral fee payments. In act 704, the facility causes compensation to be directed to the referring agent in accordance with the approach determined in act 703. In various embodiments, this involves causing direct monetary payment to be made to the referring agent or an entity associated with the referring agent, such as his or her broker or agency; causing direct monetary payment to be made to an agent who shares a broker or agency with the referring agent and is eligible to receive a referral fee; making a credit owed by a third party to an operator of the facility or the selling agent available to the referring agent or other organization to claim; identifying a certain service that has been or can be performed by the referring agent for which compensation can properly be made, such as visits to a website, signup to a website or application, the sending of messages or requesting of tours; etc. After act 704, this process concludes.

In various embodiments, the facility similarly assesses referrals for a variety of other types of services, including mortgage lending, homeowners insurance, healthcare services, legal services, etc.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system, the method comprising:
detecting referral activity in a person-to-person communication channel not dedicated to referral activities;
applying a large language model to discern in the detected referral activity first information about a referral by a referrer for a subject property being processed by a referral system, the discerned information including a property jurisdiction of the referral in which the subject property is located, a referrer jurisdiction of the referral, and a category of service of the referral;
identifying one or more referral rule representations stored in a rule store for the discerned property jurisdiction;
applying the identified one or more referral rule representations to the discerned first information to obtain a determination regarding the compliance of the referral with referral rules to which the identified one or more referral rule representations correspond;
acting in response to the determination;
discerning second information about a completed transaction for the subject property for which the subject property's seller has incurred a commission;
applying the identified one or more referral rule representations to the discerned first information and the discerned second information to select a compliant approach for compensating the referrer; and
causing the referrer to be compensated in accordance with the selected approach.

2. The method of claim 1 wherein the applying comprises determining a licensure status of the referrer by querying a licensure database.

3. The method of claim 1 wherein the obtained determination is that the referral complies with the identified one or more referral rules.

4. The method of claim 1 wherein the obtained determination is that the referral fails to comply with the identified one or more referral rules.

5. The method of claim 4 wherein the action is to cause to be presented to the referrer a notification about the referral identifying at least one noncompliant aspect of the referral.

6. The method of claim 4 wherein the action is to automatically remediate at least one noncompliant aspect of the referral.

7. The method of claim 1 wherein the obtained determination is that the referral must have a term specified by the determination to comply with the identified one or more referral rules.

8. The method of claim 7 wherein the action is to add the specified term to the referral.

9. The method of claim 1 wherein the first information comprises information published by the referrer about the subject property,
and wherein the determination is based at least in part on whether the referrer is identified by the published information.

10. The method of claim 1 wherein the selected approach specifies one or more of:
a currency for the compensation,
a share of the commission for the compensation,
a basis for the compensation, or
an entity not involved in the transaction from which the compensation will be received.

11. The method of claim 1, further comprising:
for each of a plurality of jurisdictions,
accessing one or more sources of authority about referral rules that apply to referrals for properties located in the jurisdiction;
examining the accessed sources of authority to identify new rules, changes to rules, or removal of rules relative to the referral rule representations of the rule store for the jurisdiction; and
updating the rule store based on results of the examination.

12. The method of claim 11 wherein the examining comprises:
generating a prompt specifying the analysis;
submitting the generated prompt to a generative language model; and
receiving a response from the generative language model specifying examination results.

13. The method of claim 1 wherein the discerned first information is about a referral for search criteria that are satisfied by the subject property.

14. The method of claim 1 wherein the discerned first information is about a referral for a list of properties that includes the subject property.

15. One or more instances of computer-readable media collectively storing a data structure, the data structure comprising:
a plurality of entries, each entry comprising:
first data specifying a jurisdiction to which the entry relates;
second data specifying a license portability category automatically determined for the jurisdiction from one or more sources of authority; and
third data identifying zero or more other jurisdictions automatically determined to have reciprocity with the specified jurisdiction from one or more sources of authority, such that the contents of the data structure are usable to evaluate a cross-jurisdiction referral.

16. The one or more instances of computer-readable media of claim 15, each entry further comprising:
fourth data specifying one or more of the following:
licensing requirements automatically determined for the specified jurisdiction,
advertising requirements automatically determined for the specified jurisdiction,
disclosure requirements automatically determined for the specified jurisdiction, or
privacy requirements automatically determined for the specified jurisdiction.

17. The one or more instances of computer-readable media of claim 15, each entry further comprising:
fourth data specifying referral fee requirements automatically determined for the specified jurisdiction,
such that the contents of the data structure are further usable to select a compliant referral fee payment approach for a cross-jurisdiction referral.

18. One or more instances of computer-readable media collective having contents configured to cause a computing system to perform a method, the method comprising:
discerning first information about a referral by a referrer for a subject property being processed by a referral system, the discerned first information including a referrer jurisdiction of the referral and a category of service of the referral;
discerning second information about a completed transaction for the subject property for which the subject property's seller has incurred a commission, the discerned second information including a property jurisdiction of the referral in which the subject property is located;
identifying one or more referral rule representations stored in a rule store for the discerned property jurisdiction;
applying the identified one or more referral rule representations to the discerned first information and the discerned second information to select a compliant approach for compensating the referrer; and
causing the referrer to be compensated in accordance with the selected approach.

19. The one or more instances of computer-readable media of claim 18 wherein the selected approach specifies one or more of:
a currency for the compensation,
a share of the commission for the compensation,
a basis for the compensation, or
an entity not involved in the transaction from which the compensation will be received.

20. The one or more instances of computer-readable media of claim 18 wherein the selected approach specifies a monetary form of compensation.

21. The one or more instances of computer-readable media of claim 18 wherein the selected approach specifies a non-monetary form of compensation.

22. The one or more instances of computer-readable media of claim 18 wherein the selected approach specifies a credit form of compensation.

23. A method in a computing system, the method comprising:
receiving a referral report generated by a dedicated referral system;
applying a large language model to discern in the received referral report first information about a referral by a referrer for a subject property being processed by a referral system, the discerned information including a property jurisdiction of the referral in which the subject property is located, a referrer jurisdiction of the referral, and a category of service of the referral;
identifying one or more referral rule representations stored in a rule store for the discerned property jurisdiction;
applying the identified one or more referral rule representations to the discerned first information to obtain a determination regarding the compliance of the referral with referral rules to which the identified one or more referral rule representations correspond; and
acting in response to the determination.

24. The method of claim 23 wherein the applying comprises determining a licensure status of the referrer by querying a licensure database.

25. The method of claim 23 wherein the obtained determination is that the referral complies with the identified one or more referral rules.

26. The method of claim 23 wherein the obtained determination is that the referral fails to comply with the identified one or more referral rules.

27. The method of claim 26 wherein the action is to cause to be presented to the referrer a notification about the referral identifying at least one noncompliant aspect of the referral.

28. The method of claim 26 wherein the action is to automatically remediate at least one noncompliant aspect of the referral.

29. The method of claim 23 wherein the obtained determination is that the referral must have a term specified by the determination to comply with the identified one or more referral rules.

30. The method of claim 29 wherein the action is to add the specified term to the referral.

31. The method of claim 23 wherein the first information comprises information published by the referrer about the subject property,
and wherein the determination is based at least in part on whether the referrer is identified by the published information.
